(19) United States
(12) Patent Application Publication
(10) Pub. No.: US 2025/0238189 A1
(43) Pub. Date: Jul. 24, 2025

(54) LOUDSPEAKER ROBOTICS AND AUTOMATIC ARRANGEMENT SYSTEM

(71) Applicant: PK Sound Corp., Rockyview (CA)

(72) Inventors: Jeremy BRIDGE, Calgary (CA); Lucas MARTIN, Calgary (CA); Colton SCHMIDT, Calgary (CA)

(21) Appl. No.: 19/032,634

(22) Filed: Jan. 21, 2025

Related U.S. Application Data
(60) Provisional application No. 63/624,164, filed on Jan. 23, 2024.

(51) Int. Cl. G06F 3/16; H04R 1/02; H04R 1/40; H04R 3/12

(52) U.S. Cl. CPC G06F 3/162; H04R 1/026; H04R 1/403; H04R 3/12; H04R 2201/403; H04R 2420/09

(57) ABSTRACT

Loudspeaker systems having improved robotic support and communication systems are described. The systems include improved mechanical actuation systems for adjusting a line-array of speakers enabling reduced weight and simpler designs for a given output. The systems further include improved identification systems that enable randomly connected speakers to be identified and ordered for adjustment.

### CROSS-REFERENCE TO RELATED APPLICATIONS

This application claims the benefit of U.S. Provisional Application No. 63/624,164, filed Jan. 23, 2024, the complete disclosure of which is incorporated herein by reference for all purposes.

### FIELD

Loudspeaker systems having improved robotic support and communication systems are described. The systems include improved mechanical actuation systems for adjusting a line-array of speakers enabling reduced weight and simpler designs for a given output. The systems further include improved identification systems that enable randomly connected speakers to be identified and ordered for adjustment.

### BACKGROUND

Line-array loudspeakers are a commonly used system of loudspeakers for large venues such as stadiums and arenas. A single line-array includes a series of vertically stacked speakers that are interconnected with one another to form an array of about 6-24 speakers. In a typical installation, two or more line-arrays will be suspended from an overhead support and oriented in desired directions to broadcast sound outwardly towards an audience. Depending on a number of factors including the shape and size of the broadcast area, proximity and height of seating and other factors, the horizontal orientation/angle of a number of the speakers (predominantly lower speakers) in the line-array are typically adjusted to optimize the broadcast direction of each of the speakers in the line-array.

Typically, in a stadium or arena where audience seats are raised relative to a stadium floor/stage, the top speakers are oriented to project sound to the upper and more distant seating in the broadcast area, whereas the lower speakers may be oriented to project sound downwardly towards the lower and nearer seating.

As shown in FIGS. 1 and 1A, in a usual deployment, an array of speakers is aligned into a “J” configuration where the horizontal orientation of the lower speakers is progressively increased to broadcast sound in a more downwardly direction. As shown, the array 10 may be hung from a frame 10a that is horizontal such that the top speaker is horizontal or the frame may be angled such that the top speaker is angled with respect to the horizontal.

FIG. 1A shows that the various angles between each speaker can be adjusted to obtain the desired projection angle for each individual speaker which may vary across the array. Generally, the angle relative to the horizontal will increase progressively along the length. Typically, this is shown and measured as an angle relative to the speaker above, varying from 0° to 10° as shown in FIG. 1A. The actual angle of one speaker relative to the horizontal is the cumulative total of all preceding angles. Thus, the bottom speaker in FIG. 1 is the total of 14 preceding angles greater than zero in an array of 16 speakers which in this case is 76° (total of) 10+10+8+8+6+6+6+4+4+4+2+2+2+6=76°)

In the past, line-arrays were typically installed in a manual fashion. That is, for example, in a line-array of 15 speakers, 15 speakers would be connected together on the ground and a rough adjustment of the desired orientation of the lower speakers made with the speakers lying horizontally on the ground. These speakers would be locked in position and lifted into position where they would be suspended from the desired supporting structure. In certain situations, no adjustment of the speakers could be made after being suspended.

As can be appreciated, such systems had limited or no ability to change their configuration once setup. Moreover, such systems were complicated, time-consuming and potentially dangerous to workers insomuch as adjustment was heavy work whilst being supported by and/or operating on an elevated platform.

Current systems have enabled loudspeakers to be robotically adjusted. That is, by incorporating mechanically adjustable coupling systems into a string of speakers between each individual speaker, these systems accomplished the objective of being able to remotely and quickly adjust each speaker within a line-array both at the time of initial setup but also at a later time if adjustments were required. However, current solutions are expensive, heavy and may have limited angles of deflection.

Weight and cost have a major impact on the performance and application of an array of loudspeakers. With building weight restrictions in place, the number of speakers that may be deployed may be reduced if the weight restrictions of a supporting structure cannot support the desired load of speakers that then leads to sub-optimal acoustics. Similarly, individual speakers are heavy and shipping and handling of such speakers is expensive and labor intensive if workers are having to manipulate heavy speakers.

Accordingly, there has been a general need for improvements in the design of robotic loudspeaker rigging systems that decrease the weight and cost of such systems while delivering similar or superior acoustic performance.

Further, in various applications, line-array loudspeakers are used in mobile and touring applications where they are repetitively set-up and torn-down before and after each venue performance. When prepared for shipping/transportation, the line-array is disassembled and the loudspeakers are individually moved/stacked in vehicles for shipping, almost always randomly such that the order of specific speakers in a line-array is not the same from venue to venue.

Ultimately, in order to ensure that each speaker is adjusted to a desired angle, each speaker must be individually identifiable, and its position/order known within the array.

For example, in a simple illustrative case of 4 speakers being in a line-array, Table 1 shows the actual order of speakers (from top) and the desired angle between each speaker relative to the speaker above it.

TABLE 1
Representative Example of Speaker Order/Position
at Different Venues

| | | Desired | | Desired |
|---|---|---|---|---|
| | | Angle° | | Angle° |
| | | relative to | | relative to |
| | Venue 1 | above | Venue 2 | above |
| | Actual | speaker at | Actual | speaker at |
| Speaker ID | Order | venue 1 | Order | venue 2 |
| 1 | 1 | 0 | 2 | 0 |
| 2 | 2 | 2 | 4 | 3 |
| 3 | 3 | 2 | 3 | 3 |
| 4 | 4 | 6 | 1 | 4 |

As can be seen, the desired angle between speakers at different venues may be different and the order of speakers when installed may be different from the preceding venue. Hence, in order to enable adjustment of each speaker at each venue to the desired angle, the relative position of each speaker (via its ID) must be known.

As a result, there has been a need for improved systems that enable efficient identification of the order of assembled speakers in an array such that the adjustment of angles can be made.

### SUMMARY

In accordance with the disclosure, a speaker system is described, the speaker system having a speaker cabinet having opposing first and second sidewalls; the first sidewall supporting a first upper pivot point and first lower pivot point; the second side wall having a second upper pivot point and a second lower pivot point wherein the first upper pivot point is connectable to a corresponding first lower pivot point on an adjacent speaker and the second upper pivot point is connectable to a corresponding second lower pivot point on an adjacent speaker via a linkage arm; an actuation system configured to the second sidewall and configured to extend and retract the linkage arm wherein the linkage arm, when connected to a corresponding speaker, causes two adjoining speakers to pivot about the first and second upper pivot points; wherein the actuation system is configured to provide a mechanical advantage to movement of two speakers relative to one another when the speakers have substantially zero degrees of actuation between the two speakers.

In various embodiments:
the speaker system has a single actuation system.
the actuation system includes a linearly extendable actuation arm configured to a pivoting bell crank and wherein the bell crank is configured to the linkage arm and wherein the extendable actuation arm and bell crank are configured to provide a 2:1 mechanical advantage at zero degrees of actuation.
the actuation system is configured to provide 1:1 mechanical actuation at 12 degrees of actuation.

In another embodiment, the speaker system includes a speaker ID system configured to the speaker cabinet, the speaker ID system configured to connect an array of speakers together via upstream and downstream network connections and wherein the speaker ID system receives data from downstream speaker in an array for calculating speaker position in the array.

In one embodiment the speaker ID system includes: an ethernet in port for connecting a speaker to an upstream network; an ethernet out port for connecting a speaker to a downstream network; a switch for receiving network packet data from the ethernet out port; an MCU configured to the switch for receive network packet data and tabulating received network packet data having speaker ID information and received port information.

In one embodiment, the MCU is configured to report tabulated network packet data from a downstream network to an upstream network.

In another embodiment, the upstream network is configured to receive tabulated network packet data from multiple speakers in an array of speakers and is configured to compare tabulated network packet data from each speaker to determine order of an individual speaker in an array of speakers.

In another aspect, a speaker ID and ordering system is described, the system having a network processor configured to connect to multiple speakers in a line-array wherein each speaker in the line-array is configured with: an ethernet in port for connecting a speaker to an upstream network; an ethernet out port for connecting a speaker to a downstream network; a switch for receiving network packet data from the ethernet out port; an MCU configured to the switch for receive network packet data and tabulating received network packet data having speaker ID information and received port information; wherein the MCU is configured to report tabulated network packet data from a downstream network to an upstream network; and, wherein the network processor is configured to receive tabulated network packet data from multiple speakers in the line-array and is configured to compare tabulated network packet data from each speaker to determine order of an individual speaker in an array of speakers.

### BRIEF DESCRIPTION OF THE DRAWINGS

Various objects, features and advantages of the disclosure will be apparent from the following description of particular embodiments of the disclosure, as illustrated in the accompanying drawings. The drawings are not necessarily to scale, emphasis instead being placed upon illustrating the principles of various embodiments of the disclosure. Similar reference numerals indicate similar components.

FIGS. 1 and 1A are side views of a typical system of line-array loudspeakers showing how the angles of speakers in the array can be adjusted.

FIG. 2 is a perspective view of two speakers and a connection system in accordance with one embodiment of the disclosure.

FIGS. 3 and 3A are exploded diagrams showing the components of an actuation system and speaker (FIG. 3) and actuation system (FIG. 3a) in accordance with one embodiment of the disclosure.

FIG. 3B is a side-view of an assembled actuation system and the relative position of components of the actuation system.

FIG. 3C is a side-view of a bell crank in accordance with on embodiment of the disclosure.

FIGS. 4 and 4A-4B are schematic linkage diagrams showing the positions of linkages at varying angles in accordance with one embodiment of the disclosure.

FIG. 5 is a schematic diagram of a speaker communication system in accordance with one embodiment of the disclosure.

FIG. 6 is a schematic diagram of a number of speakers connected to one another in a daisy-chain configuration in accordance with one embodiment of the disclosure.

### DETAILED DESCRIPTION

With reference to the figures, improved speaker systems having actuation systems enabling automatic adjustment of inter-speaker angles are described together with systems enabling identification of the relative position of speakers in an array.

### Terminology

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be understood that the terms “includes”, “including”, “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items.

Spatially relative terms may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a feature in the figures is inverted, elements described as “under” or “beneath” other elements or features would then be oriented “over” the other elements or features. Thus, the exemplary term “under” can encompass both an orientation of over and under. A feature may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present.

It will be understood that, although the terms “first”, “second”, etc. may be used herein to describe various elements, components, etc., these elements, components, etc. should not be limited by these terms. These terms are only used to distinguish one element, component, etc. from another element, component. Thus, a “first” element, or component discussed herein could also be termed a “second” element or component without departing from the teachings of the present disclosure. In addition, the sequence of operations (or steps) is not limited to the order presented in the claims or figures unless specifically indicated otherwise.

Other than described herein, or unless otherwise expressly specified, all of the numerical ranges, amounts, values and percentages, such as those for amounts of materials, elemental contents, times and temperatures, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Unless otherwise defined, all technical and scientific terms used herein have the same meaning as commonly understood by one of ordinary skill in the art to which this disclosure belongs.

Various aspects of the disclosure will now be described with reference to the figures. The disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Moreover, the drawings are not necessarily drawn to scale and are intended to emphasize principles of operation rather than precise dimensions.

In a first aspect, an improved system for interconnecting and enabling adjustment of an array of loudspeakers is described.

By way of background, and for reference, a representative prior art loudspeaker system (LS) capable of being formed into a line-array and each speaker having output in the range of 149 db can weigh in the range of 118 kg. Each speaker in the line-array, individually includes a combination of a speaker cabinet with integral drivers, electronics and connectors configured to/within the speaker cabinet. In addition, such speakers enabling the interconnection of individual speakers into an array include electro-mechanical actuation systems on opposing sides of the cabinet configured to enable connection and angular positioning of individual speakers with respect to one another.

In such prior art systems, when speakers are flown in an array of up to 24 elements, the total mass of such an array can be up to about 2832 kg. As is understood, the speakers at the top of the array have the greatest load which becomes progressively smaller with each speaker down the array.

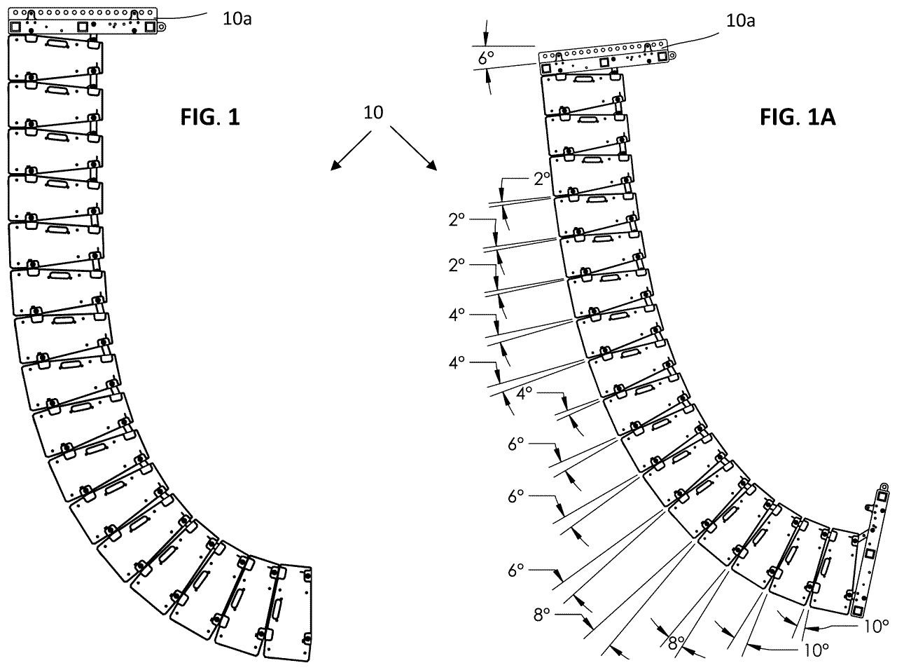

Generally, the upper speakers in the array when set-up at a venue typically have a smaller inter-module angle than speakers at the bottom of the array as shown in FIG. 1A. Also, as noted above, the lower speakers support lower loads due to there being a progressively smaller number of speakers connected below any given speaker system in the array.

With a greater weight of speakers being suspended from an upper speaker, the forces required to initiate movement/positioning of the upper speakers is greater than the forces required to move/position the lower speakers.

In the past, speakers were provided with a dual actuation system on opposite sides of the speaker cabinet, the dual actuation system being required to enable movement of the upper speakers given the high load on these upper speakers. Importantly, as such speaker systems are designed for modularity and to minimize the risks of technicians making installation errors, actuation systems were consistent for all speakers that could be configured into the array, thus, those speakers at the bottom of the array had overly powerful actuators for the load beneath. Notwithstanding this, given the industry, all speakers designed for a particular array need to be consistent in size/configuration.

In addition, size restrictions on speaker cabinets required the use of dual actuators.

The inventors recognized that modifications in an electro-mechanical actuation system could substantially reduce both weight and cost of individual speakers designed to be connected into an array.

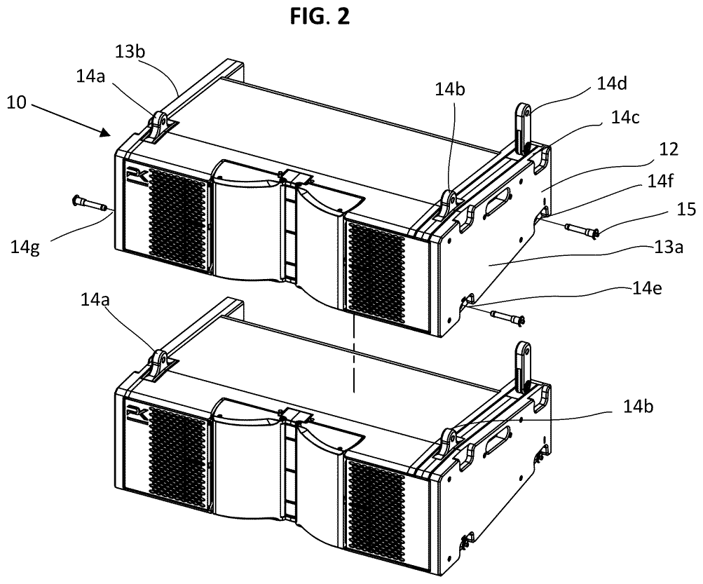

As shown in FIG. 2, speakers 10 having a single actuation system 12 are described that enable separate speakers to be connected together and mechanically adjusted with respect to one another. Each speaker 10 is configured with end plates assemblies 13a, 13b having upper pin receptacles 14a, 14b at a forward side of the speaker and pin receptacle 14c at a rear side of the speaker. In addition, the speaker includes lower pin receptacles 14e, 14g at a forward side of the speaker and lower pin receptacle 14f at a rear side of the speaker. By placement of one speaker on top of another, pins 15 may be inserted into mating receptacles to lock speakers together such that the forward receptacles enable pivotal movement about an axis extending between the forward receptacles. Linkage 14d may be provided to provide mechanical separation between rear receptacles as explained in greater detail below.

That is, pin receptacles 14a and 14b are simple pivot points enabling two speakers to be pivoted with respect to one another whereas pin receptacle 14c and linkage arm 14d are displaced relative to one speaker to enable an adjustment of inter-speaker angle between two speakers.

In accordance with the disclosure, end plate assembly 13b does not include an actuation system and simply enables connection to a corresponding end plate assembly on another speaker via receptacles 14a and 14g.

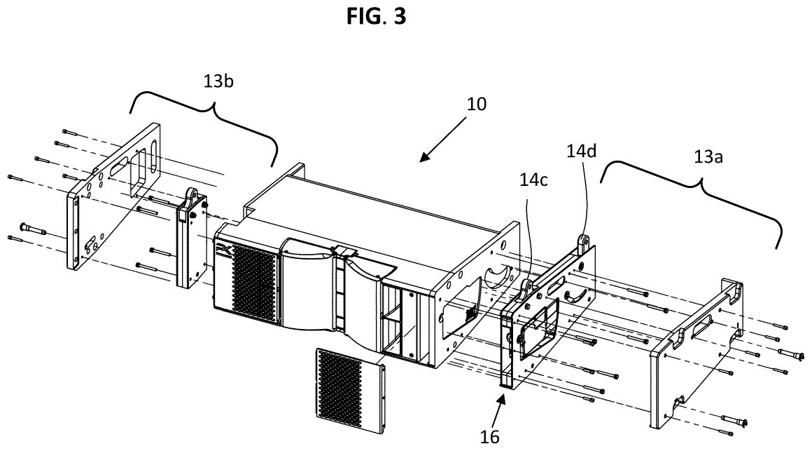

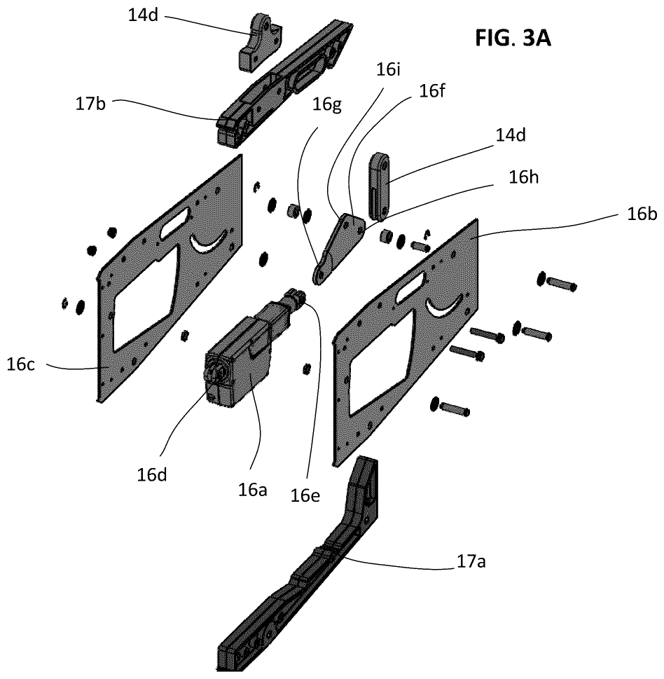

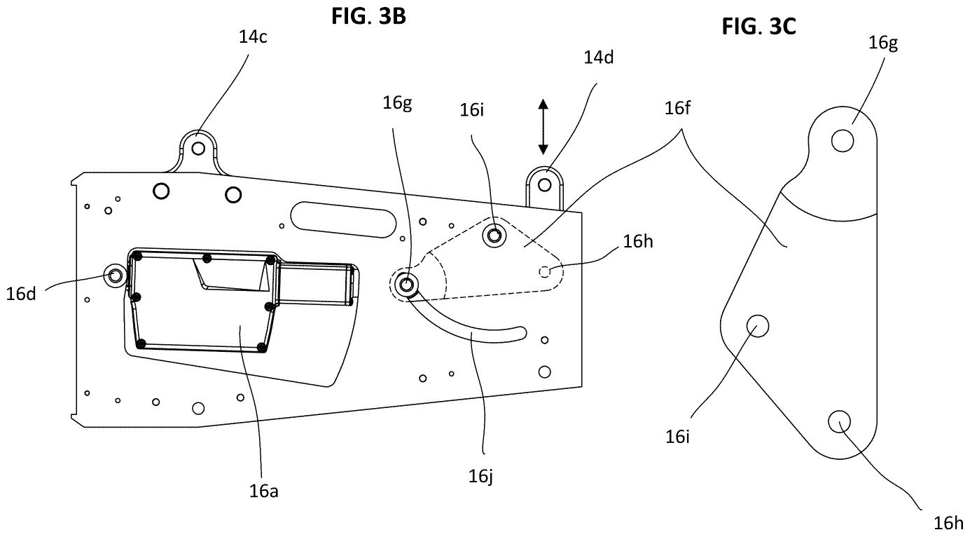

As shown in FIGS. 3 and 3A, end plate assembly 13a includes an electromechanical actuation system including linear actuator 16a configured to mounting plates 16b, 16c. The linear actuator 16a includes a fixed pivot anchor 16d configured to be pivotally connected to the mounting plates and extending pivot anchor 16e that is extendable relative to the linear actuator 16a. Actuator 16a is secured to the end plates 16b, 16c and spacers 17a, 17b may be utilized to separate the end plates and/or secure pivots 14d, 14c.

The extending pivot anchor 16e is configured to pivotally connect to bell crank 16f.

Referring now to FIGS. 3B and 3C, bell crank 16f has three pivots including actuator pivot 16g, fixed crank pivot 16i and linkage pivot 16h. Actuator pivot 16g connects to extending pivot anchor 16e, fixed crank pivot 16i is connected to mounting plates 16b, 16c and linkage pivot 16h is configured to connect to linkage arm 14d.

Generally, as actuator 16a extends, actuator pivot 16g and pivot anchor 16e move within end plate slot 16j causing bell crank 16f to pivot about fixed crank pivot 16i.

Movement of the bell crank about crank pivot 16i causes extension or retraction of linkage arm 14d relative to the speaker such that when two speakers are connected together, one speaker pivots about pivot points 14a, 14b thus causing a rear region of the speaker to move relative to an adjacent speaker.

Collectively, each of the forgoing pivots, bell crank, actuator and the position of each relative to each other are a system of levers that define a mechanical actuation system providing improved performance for adjustment of multiple speakers.

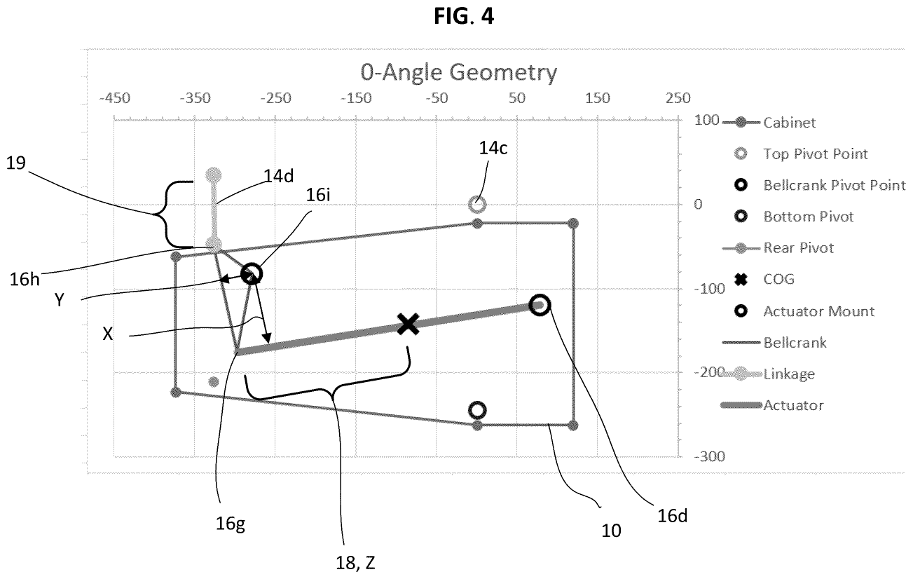

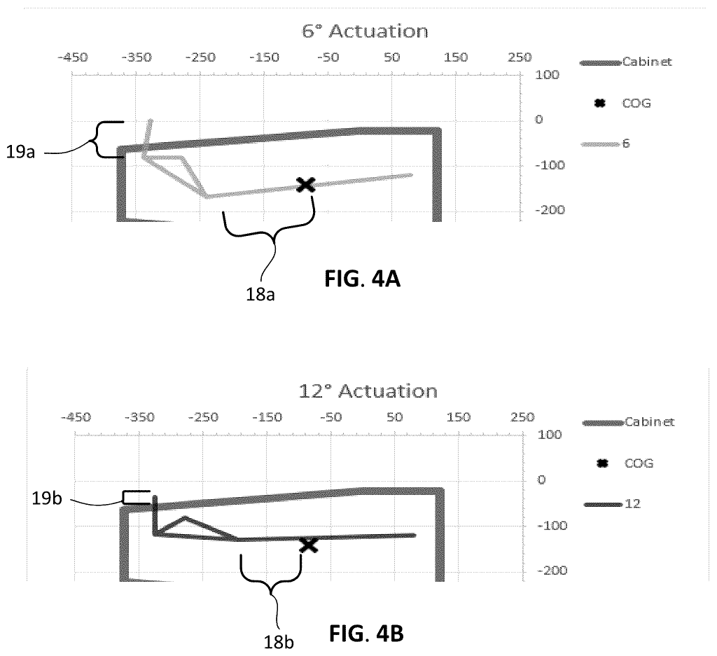

As shown in FIGS. 4-4B, the various pivot points and levers are shown schematically in different actuation positions including zero, 6 and 12 degrees of actuation.

As shown in each of FIGS. 4, 4A and 4B, the positions of each of the pivot points are shown with different degrees of actuation of the actuator 16a. FIG. 4 shows actuator arm length 18, FIG. 4A shows actuator arm length 18a and FIG. 4B shows actuator arm length 18b (where 18>18a>18b) and the corresponding effect on the position of linkage arm 14d and its position 19, 19a, 19b relative to speaker cabinet 10. As can be seen, as actuator arm length decreases as shown progressively by 18, 18a and 18b, linkage arm is pulled downwardly thus drawing an adjoining speaker closer.

Importantly, the actuator system is configured such that a defined mechanical advantage is realized with zero degrees of actuation and a different mechanical advantage is realized at progressively higher degrees of actuation. In one embodiment, the mechanical advantage is about 2:1 at zero degrees of actuation and about 1:1 at 12 degrees.

That is, as introduced above, movement of top speakers in an array requires more force/energy to initiate movement as the load on upper speakers is greater but typically, as described above, only require a few degrees of movement. Accordingly, the subject system is configured to provide mechanical advantage to initiate movement from zero degrees, but less mechanical advantage as the degree of actuation increases. Importantly, as the load is decreasing lower in the array, despite decreasing mechanical advantage, movement is accomplished without needing more powerful actuators.

Also, as the system is configured with mechanical advantage at lower degrees of actuation, the need to duplicate actuation systems as shown in the prior art is obviated.

Thus, both significant cost and weight savings are realized as a significant cost in the construction of speaker/actuation system is the actuation system in addition to the weight of a second actuation system. In other words, by enabling defined mechanical actuation, the weight of a speaker can be substantially reduced as the 2nd actuation system is not required. This has the benefit of reducing costs of the speaker and enabling longer arrays of speakers to be flown from a given structure.

Specifically, the mechanical advantage is realized by the respective lengths of lever arms X and Y on the bell crank pivot 16i. Lever arm X is at 90 degrees to the actuator arm lever Z and lever arm Y is parallel as shown in FIG. 4. In this configuration, where X=˜2Y, one unit of force and movement of Z (i.e. shortening of the actuator arm) realizes approximately one half unit of movement of linkage arm 14d. As the actuator lever Z becomes shorter, the length of lever X becomes smaller relative to lever Y; hence, the mechanical advantage decreases. However, as noted above, as the upper and loaded speakers do not move beyond a few degrees (e.g. up to about 2 degrees), the decrease in mechanical advantage has no substantive effect.

Practically, the speaker systems incorporating this configuration has reduced the weight of components required for vertical actuation by approximately 50-70%. For example, new loudspeakers can weigh about 31 kg whilst providing an output of 145 db. At 50% of the weight of a prior art speaker having two actuation systems, this translates to an increase in decibels per kg of about 107%.

### Loudspeaker Auto-Identification

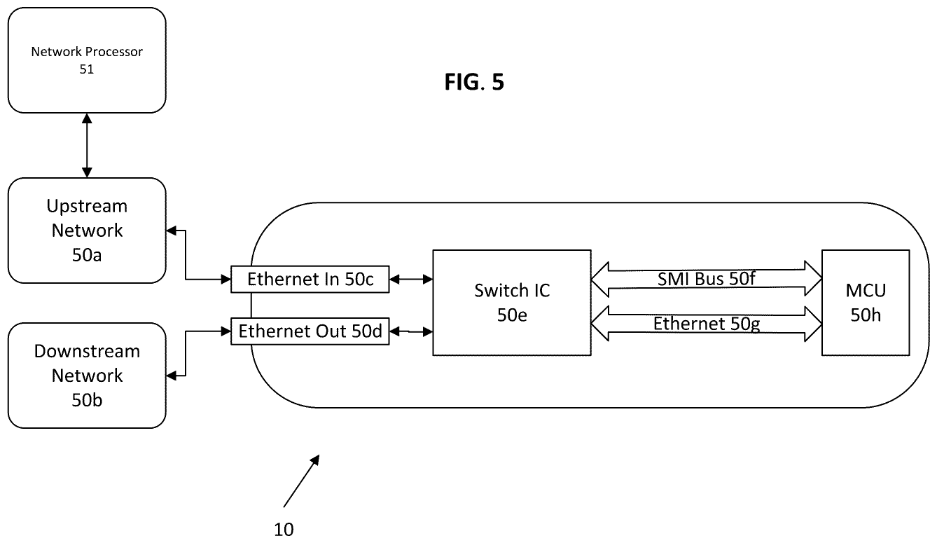

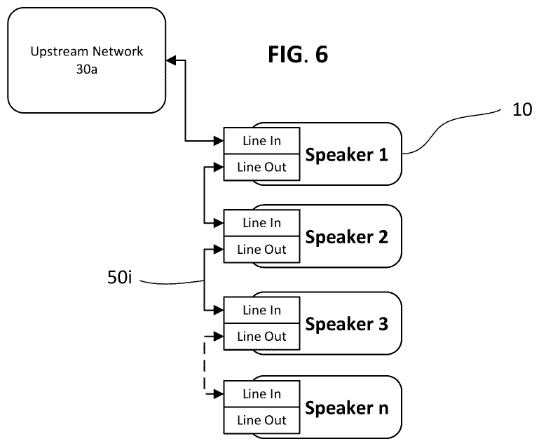

In another aspect, with reference to FIGS. 5 and 6, systems for enabling auto-identification of speakers and location in an array are described to enable associated control software to adjust the position of each speaker within a single array network or within multiple arrays.

Each speaker 10 in an array, besides the uppermost and lowermost speakers is connected via ethernet to upstream and downstream speakers. The uppermost speaker is connected to a wider network linking multiple line-arrays together and a network processor 51.

Each speaker 10 includes a switch IC 50e having two separate network interfaces 50c and 50d enabling connection to upstream network 50a and downstream network 50b. Each switch IC 50e keeps track of which port a packet from an individual speaker ID (e.g. MAC address) enters the switch IC 50e in an internal address table (e.g. MAC address table).

By way of simple example, a speaker ID “6” enters a switch IC on port 2 (e.g. a downstream port) and is entered into the address table.

This ID table information is accessible to be read by a speaker MCU 50h present in the speaker over a Serial Management Interface (SMI) bus 50f. The MCU 50h knows/determines that ID information coming in from a downstream port (e.g. port 2) is lower in the array than the speaker making this determination. This table data can then be reported back to the central network wherein table data from each speaker can be compared and sorted such that the order of speaker IDs of the array can be determined.

Additional control software can then be activated to enable specific speaker orientation.

Importantly, this enables a user to quickly and accurately bring up the system without worrying about keeping track of individual devices, IP numbers, or serial numbers.

Although embodiments of the present disclosure have been described and illustrated with respect to preferred embodiments and preferred uses thereof, it is not to be so limited since modifications and changes can be made therein which are within the full, intended scope of the disclosure as understood by those skilled in the art.

1. A speaker system comprising:
a speaker cabinet having opposing first and second sidewalls,
the first sidewall supporting a first upper pivot point and first lower pivot point;
the second side wall having a second upper pivot point and a second lower pivot point wherein the first upper pivot point is connectable to a corresponding first lower pivot point on an adjacent speaker and the second upper pivot point is connectable to a corresponding second lower pivot point on an adjacent speaker via a linkage arm;
an actuation system configured to the second sidewall and configured to extend and retract the linkage arm wherein the linkage arm, when connected to a corresponding speaker, causes two adjoining speakers to pivot about the first and second upper pivot points;
wherein the actuation system is configured to provide a mechanical advantage to movement of two speakers relative to one another when the speakers have substantially zero degrees of actuation between the two speakers.

2. The speaker system as in claim 1 wherein the speaker system has a single actuation system.

3. The speaker system as in claim 2 wherein the actuation system includes a linearly extendable actuation arm configured to a pivoting bell crank and wherein the bell crank is configured to the linkage arm and wherein the extendable actuation arm and bell crank are configured to provide a 2:1 mechanical advantage at zero degrees of actuation.

4. The speaker system as in claim 3 wherein the actuation system is configured to provide 1:1 mechanical actuation at 12 degrees of actuation.

5. The speaker system as in claim 1 further comprising a speaker ID system configured to the speaker cabinet, the speaker ID system configured to connect an array of speakers together via upstream and downstream network connections and wherein the speaker ID system receives data from downstream speaker in an array for calculating speaker position in the array.

6. The speaker system as in claim 5 wherein the speaker ID system includes:
an ethernet in port for connecting a speaker to an upstream network;
an ethernet out port for connecting a speaker to a downstream network;
a switch for receiving network packet data from the ethernet out port;
an MCU configured to the switch for receive network packet data and tabulating received network packet data having speaker ID information and received port information.

7. The speaker system as in claim 6 wherein the MCU is configured to report tabulated network packet data from a downstream network to an upstream network.

8. The speaker system as in claim 7 wherein the upstream network is configured to receive tabulated network packet data from multiple speakers in an array of speakers and is configured to compare tabulated network packet data from each speaker to determine order of an individual speaker in an array of speakers.

9. A speaker ID and ordering system comprising:
a network processor configured to connect to multiple speakers in a line-array wherein each speaker in the line-array is configured with:
an ethernet in port for connecting a speaker to an upstream network;
an ethernet out port for connecting a speaker to a downstream network;
a switch for receiving network packet data from the ethernet out port;
an MCU configured to the switch for receive network packet data and tabulating received network packet data having speaker ID information and received port information;
wherein the MCU is configured to report tabulated network packet data from a downstream network to an upstream network; and,
wherein the network processor is configured to receive tabulated network packet data from multiple speakers in the line-array and is configured to compare tabulated network packet data from each speaker to determine order of an individual speaker in an array of speakers.
